(19) United States
(12) Patent Application Publication
(10) Pub. No.: US 2005/0278643 A1
(43) Pub. Date: Dec. 15, 2005

(54) Display control apparatus, information display apparatus, display system, display control program and display control method

(75) Inventors: Hiromi Ukai, Machida (JP); Masato Ishii, Tokyo (JP); Hirofumi Nagano, Yokohama (JP); Toshiyuki Morita, Yokohama (JP)

Correspondence Address: MCDERMOTT WILL & EMERY LLP, 600 13TH STREET, N.W., WASHINGTON, DC, 20005-3096, US

(73) Assignee: Hitachi, Ltd.

(21) Appl. No.: 11/149,257

(22) Filed: Jun. 10, 2005

(30) Foreign Application Priority Data
Jun. 15, 2004 (JP) 2004-177040

(51) Int. Cl. G06F 3/00

(52) U.S. Cl. 715/751; 715/754; 715/758; 715/759

(57) ABSTRACT

A display control apparatus which displays information items from outside on a screen of a display apparatus, comprises a receiver for receiving the information from outside, and a controller which allocates in the screen multiple display areas respectively associated with multiple communication addresses that are different from one another, and displays said information items in said display areas respectively, said information items being sent to said communication addresses respectively associated with said display areas.

### CLAIM OF PRIORITY

The present application claims priority from Japanese application serial No. 2004-177040 filed on Jun. 15, 2004, the content of which is hereby incorporated by reference into this application.

### BACKGROUND

The present invention relates to a display control apparatus which is capable of displaying on a screen multiple display information items obtained from exterior communications, an information display apparatus provided with this display control apparatus, an information service management apparatus which provides those apparatuses with the display information items, a display system provided with those elements above, a display control program, and a display control method.

Conventionally, as a technique to display information such as electronic mail (hereinafter, referred to as “e-mail”), U.S. patent application Publication No. 2002/138584 (JP-A-2002-351789) discloses a system that divides a display screen into multiple display areas, and e-mails from particular senders are displayed respectively in the display areas. U.S. patent application Publication No. 2002/138584 further discloses that an apparatus which receives an e-mail is provided with one e-mail address and each display area is provided with an identifier. Even more particularly, U.S. patent application Publication No. 2002/138584 further discloses that the sender specifies the mail address together with the identifier of the display area, and when a main text of the e-mail is sent to the apparatus, the apparatus as a receiver displays the main text of the e-mail in the display area indicated by the identifier.

Even though there is an advantage that several e-mails can be viewed at once in the system as disclosed by U.S. patent application Publication No. 2002/138584, an apparatus as a mail sender has to accept an input of identifier indicating the display area together with the mail address of the receiver side. Therefore, it is necessary that the apparatus as a sender is to be a dedicated one, and a general-purpose communication terminal cannot be used.

### SUMMARY

The object of the present invention is to provide an apparatus, a system, a program, and a method, allowing multiple display information items from multiple communication terminals to be displayed on a screen.

The present invention is provided with an information display apparatus (for example, a display terminal) which displays information from outside (for example, e-mail message), and a management apparatus (for example, management server) which delivers multiple information items from outside to the information display apparatus via a network, wherein,

the information display apparatus is provided with a display device which displays the information items, a receiver which receives the information items from outside, and a controller which allocates in a screen of the display device, multiple display areas respectively associated with multiple communication addresses (for example, e-mail address) being different from one another, and displays the information items respectively in the display areas, the information items being sent to the communication addresses respectively associated with the display areas, and,

the management apparatus is provided with a receiver which receives the information items sent to the multiple communication addresses from outside, a storage device which stores a table holding the multiple communication addresses, types of information items respectively associated with the communication addresses, and an identifier of the information display apparatus associated with each of the communication addresses, and a management device which refers to the table to know the identifier of the information display apparatus as a destination of the information item that is sent to any one of the multiple communication addresses and the type of the information item, and transmits to the information display apparatus having the identifier, the information item and the type of the information.

According to the present invention, since the display control apparatus sets in the display screen, multiple display areas that are respectively associated with communication addresses being different from one another, it is possible for a sender to display information item on the display screen, within a display area in which the sender desires to display the information item, out of the multiple display areas, when the sender transmits the information item to the communication address associated with the desired display area. With the configuration above, the sender is allowed to utilize a general-purpose communication terminal.

### BRIEF DESCRIPTION OF THE DRAWINGS

FIG. 1 is a functional block diagram showing an information display system according to one embodiment of the present invention.

FIG. 2 is a circuitry block diagram showing the information display system according one embodiment of the present invention.

FIG. 3 is an illustration showing a display mode on a display terminal according to one embodiment of the present invention.

FIG. 4A and FIG. 4B are illustrations showing data structures of management tables held by the display terminal according to one embodiment of the present invention. FIG. 4A is an illustration showing data structure of the management table held by the display terminal A and FIG. 4B is an illustration showing data structure of the management table held by the display terminal B.

FIG. 5 is an illustration showing data structure of DS management table that is held by a management server according to one embodiment of the present invention.

FIG. 6 is an illustration showing data structure of mail management table held by the management server according to one embodiment of the present invention.

FIG. 7A and FIG. 7B are illustrations showing data structures that are stored in a database according to one embodiment of the present invention. FIG. 7A is an illustration showing data structure when a SHARE type message is stored, and FIG. 7B is an illustration showing data structure when SENDER type message or FREE type message is stored.

FIG. 8 is an illustration showing data structure of message display data that is transmitted to each display terminal from the management server according to one embodiment of the present invention.

FIG. 9 is a flow chart showing operations of e-mail receiving section of the management server according to one embodiment of the present invention.

FIG. 10 is a flow chart showing operations of e-mail management section of the management server according to one embodiment of the present invention.

FIG. 11 is a flow chart showing operations of message accepting section of the display terminal according to one embodiment of the present invention.

FIG. 12 is a flow chart showing operations of display control section of the display terminal according to one embodiment of the present invention.

### DETAILED DESCRIPTION OF THE PREFERRED EMBODIMENTS

Hereinafter, an information display system according to one embodiment of the present invention will be explained with reference to the accompanying drawings.

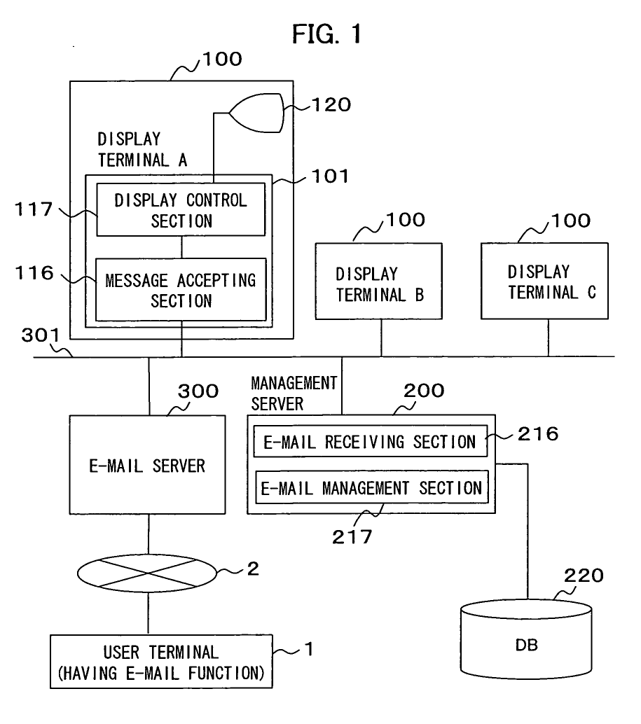

As shown in FIG. 1, the information display system according to the present embodiment is provided with multiple display terminals 100 serving as bulletin board system, a management server 200 which provides messages as display information to the multiple display terminals 100, database 220 which temporarily stores e-mail data as a message to be displayed on the display terminal 100, e-mail server 300 which is connected to network 2, and LAN 301 which connects the elements above with one another.

The display terminal 100 includes display unit 120 having a display screen, and display control apparatus 101 which controls the display unit 120. The display control apparatus functionally includes a message accepting section 116 which accepts a message from the management server 200 via the LAN 301, and a display control section 117 which allows the display unit 120 to display the message accepted by the message accepting section 116.

The management server 200 functionally includes e-mail receiving section 216 which receives an e-mail from the e-mail server 300 via the LAN 301, and e-mail management section 217 which stores data of the e-mail received by the e-mail receiving section 216 into the database 220 as data of message and delivers the message to the multiple display terminals 100.

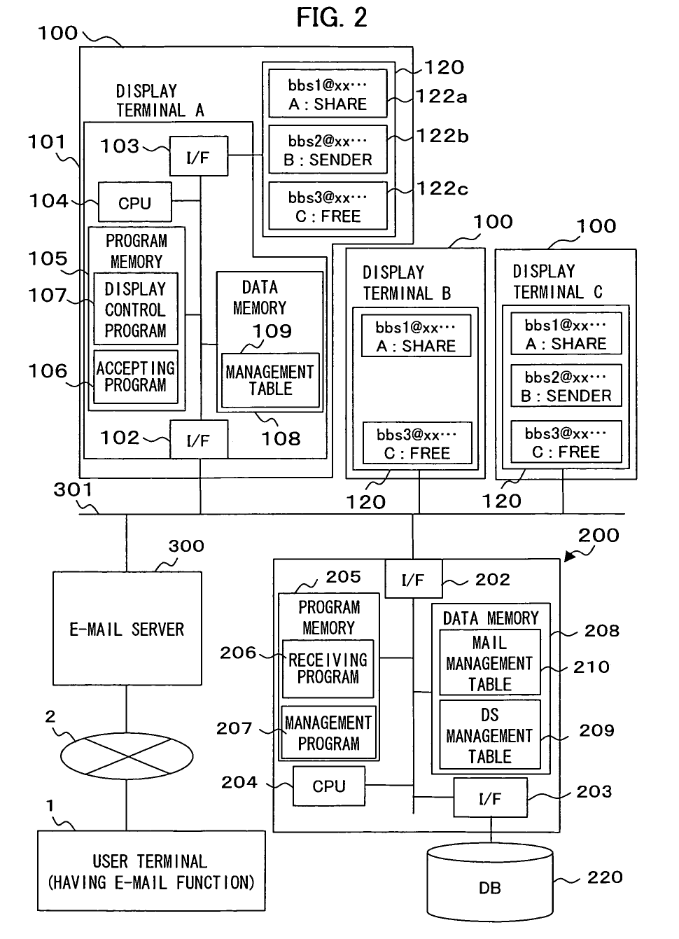

As shown in FIG. 2, the display control apparatus 101 of the display terminal 100 includes communication interface 102 which is connected to the LAN 301, display interface 103 which is connected to the display unit 120, program memory 105 which stores various programs, data memory 108 which stores various data, and CPU 104 which executes various programs and the like stored in the program memory 105. The program memory 105 stores an accepting program 106 which implements a function as the aforementioned message accepting section 116, and a display control program 107 which implements a function as the display control section 117. In the data memory 108, there are reserved an area for temporarily expanding display data to be displayed on the display unit 120, and an area for a management table 109 and the like, which will be described below. The aforementioned message accepting section 116 of the display control apparatus 101 includes program memory 105 in which the accepting program 106 is stored, CPU 104 which executes the accepting program 106, and communication interface 102. In addition, the aforementioned display control section 117 includes the program memory 105 which stores a display control program, the CPU 104 which executes this display control program 107, and display interface 103.

The management server 200 includes communication interface 202 which is connected to the LAN 301, DB interface 203 which is connected to the database 220, program memory 205 which stores various programs, data memory 208 which stores various data, and CPU 204 which executes various programs and the like stored in the program memory 205. The program memory 205 stores a receiving program 206 to implement a function as the aforementioned e-mail receiving section 216, and e-mail management program 207 to implement a function as the e-mail management section 217. In the data memory 208, there are reserved areas for mail management table 210 and DS management table 209 and the like, which will be described below.

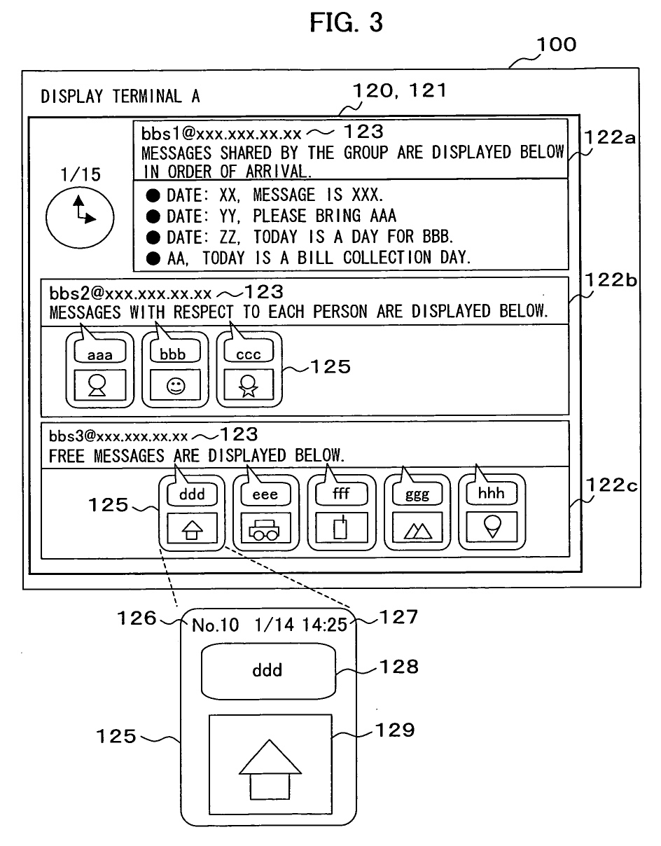

FIG. 3 shows an example of screen display of the display terminal A. The screen 121 is partitioned into three large areas, being arranged from the top, display area A 122a, display area B 122b, and display area C 122c. Mail addresses are respectively allocated to the display areas 122a, 122b, and 122c, and a mail address area 123 is provided in the upper part of each area to indicate the mail address. The display area A 122a is an area to display a message, in order of arrival, which is common to all the persons who may exist in the space where the display 120 is installed (hereinafter, referred to as “SHARE type message”). In the example of the screen, there are displayed the latest four messages. The display area B 122b is an area to display one message with respect to each message sender (hereinafter, referred to as “SENDER type message”). In the example of the screen, there are displayed messages from three senders, i.e., three messages. The display area C 122c is an area to display a free message (hereinafter, referred to as “FREE type message”), which has no restriction in the type of message as display information, unlike the above areas 122a and 122b.

Both of the display area B 122b and the display area 122c are areas for displaying a message within a message card 125. The message card 125 includes a message ID area 126 on the upper left part to display a message ID, a sending date and time area 127 on the upper right part to display the date and time when the message is transmitted, a text area 128 in the middle part to display a text of the message being transmitted, and an image area 129 on the lower part to display an image of the message being transmitted. The message ID is unique to each message, and a message sender may delete the message or attach a reply to the message by designating this message ID.

A plurality of message cards 125 in the display area B 122b and the display area C 122c are arranged horizontally on the screen 121, and each of the message cards 125 appears from the right edge, moves slowly towards the left, disappears at the left edge, ant then appears from the right edge again. Accordingly, it is possible to display message cards 125, the number of which is equal to or larger than the number of message cards which fits into the width of each message area 122b, 122c. In order words, a larger number of messages can be displayed, compared to a display method which displays the messages in static manner.

As described above, since the display area B 122b is an area to specify a sender of the message and to display one message with respect to each sender, when a new message arrives having the same sender mail address as that of the message already displayed, the old message is replaced by the new message. If the new message includes only text data, the image is not updated. Attaching a photograph of the sender to the mail as the image data may make it easier to recognize who is the sender. Therefore, the display area B 122b may be used to display a schedule of the day, to communicate from the outside to announce where the sender is currently located, or to display self-introduction.

Since the display area C 122c is an area to display a free message as described above, it may be used to discuss a certain theme, or to communicate from a business trip destination to inform the current status.

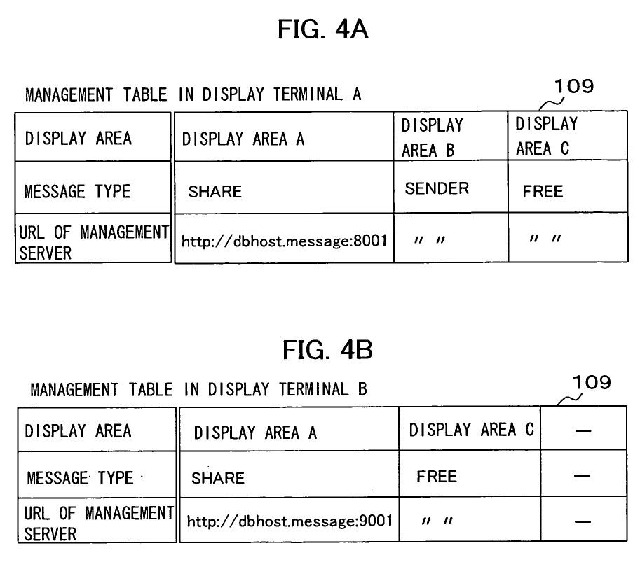

As shown in FIG. 4A and FIG. 4B, the management table 109 stored in the data memory 109 of the display control apparatus 101 includes, a display area field in which a type of the display area is stored, a message type field to store the message type, and URL field to store URL of the management server 200. For example, as explained in the above description with reference to FIG. 3, the display terminal A sets the display A 122a, the display area B 122b, and the display area C 122c in the screen, the display area field of the display terminal A stores the display area A, display area B, and display area C, as shown in FIG. 4A. As described above, the display area A displays a SHARE type message, the display area B displays a SENDER type message, and the display area C displays a FREE type message. Therefore, the message type field of the display terminal A stores SHARE, SENDER, and FREE. Since the display terminal B here sets in the screen, the display area A 122a and display area C 122c, the display area field of the display terminal B stores the display area A and the display area C as shown in FIG. 4B. The message type field of the display terminal B stores SHARE and FREE.

The display terminal 100 is connected with an input device or a computer on which an input device is mounted, and contents of the management table 109 can be changed from thus connected device. Therefore, the display area of each display terminal 100 can be modified freely.

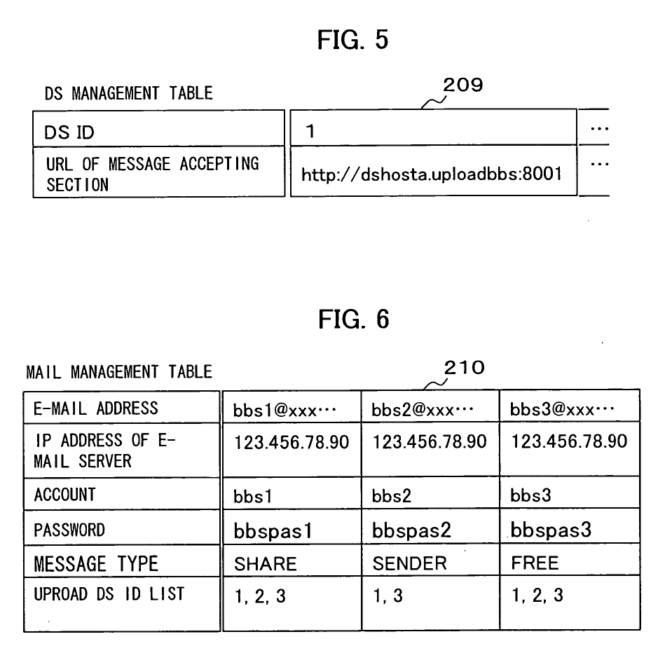

As shown in FIG. 5, the DS management table 209 stored in the data memory 208 of the management server 200 includes ID field for storing ID of each display terminal (DS), and URL field to store URL of each display terminal.

As shown in FIG. 6, the mail management table 210 stored in the data memory 208 of the management server 200 includes, an e-mail address field to store an e-mail address to send a mail from the user terminal 1 to the e-mail server 300 via the network 2, IP address field to store an IP address of the e-mail server 300, account field to store an account regarding each e-mail address, password field to store a password regarding each e-mail address, message type field to store a type of the message displayed in the display area being associated with each e-mail address, and upload DS ID list field to store ID of the display terminal 100 to which a mail, i.e., a message, addressed to each e-mail address is provided. The example as shown in FIG. 6 indicates that a message sent to the e-mail address “bbs1@xxx . . . ” is a SHARE type message, and it is provided to the display terminals having the display terminal IDs 1, 2 and 3, corresponding to the display terminal A, display terminal B, and display terminal C, respectively. The message sent to the e-mail address “bbs2@xxx . . . ” is a SENDER type message, and it is provided to the display terminals having the display terminal IDs 1 and 3, corresponding to the display terminal A and the display terminal C, respectively. The message sent to the e-mail address “bbs3@xxx . . . ” is a FREE type message, and it is provided to the display terminals having the display terminal IDs 1, 2 and 3, corresponding to the display terminal A, the display terminal B, and the display terminal C, respectively.

In other words, the example indicates that, as shown in FIG. 2, the SHARE type message sent to the address “bbs1@xxx . . . ”, the SENDER type message sent to the address “bbs2@xxx . . . ”, and the FREE type message sent to the address “bbs3@xxx . . . ” are displayed on the display terminal A 100. In addition, the SHARE type message sent to the address “bbs1@xxx . . . ”, and the FREE type message sent to the address “bbs3@xxx . . . ” are displayed on the display terminal B 100. On the display terminal C 100, just like the display terminal A, there are displayed the SHARE type message sent to the address “bbs1@xxx . . . ”, the SENDER type message sent to the address “bbs2@xxx . . . ”, and the FREE type message sent to the address “bbs3@xxx . . . ”.

As thus described, it is possible to display a message sent to a certain mail address on multiple display terminals 100, by managing the ID of the display terminal 100 to which the message is given. In other words, a usage is found such that one display terminal 100 and another display terminal 100 can share one mail address. For example, if the present invention is applied to an office, there is found a usage such that a mail address for SHARE type and a mail address for FREE type are shared among a plurality of departments in the office, and only the mail address for SENDER type can be prepared with respect to each department.

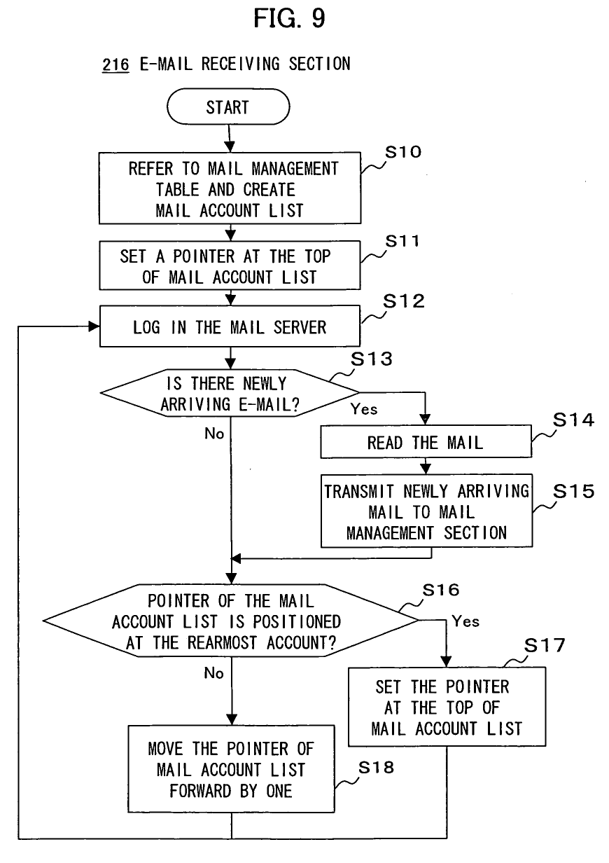

Next, according to the flow chart as shown in FIG. 9, operations of the e-mail receiving section 216 of the management server 200 will be explained.

When the e-mail receiving section 216 is started up, it refers to the mail management table 210 as shown in FIG. 6, and creates a mail account list as a target for polling (step 10). Next, the e-mail receiving section sets a pointer at the top of the mail account list thus created (step 11), logs in the e-mail server 300 with the first account indicated by the pointer (step 12), and checks whether or not there is a newly arriving e-mail (step 13). If there is a newly arriving e-mail, the e-mail receiving section reads out the mail (step 14), and gives the newly arriving e-mail to the e-mail management section 217 (step 15). If it is determined in step 13 that there is no newly arriving e-mail, and after the processing in step 15 is completed, the e-mail receiving section checks whether or not the pointer of the mail account list indicates the rearmost account (step 16), and if it is the rearmost account, the pointer is set to the top of the mail account list (step 17). On the other hand, if it is not the rearmost account, the e-mail receiving section moves the pointer forward by one (step 18), and the processing is returned to step 12 to check the next account.

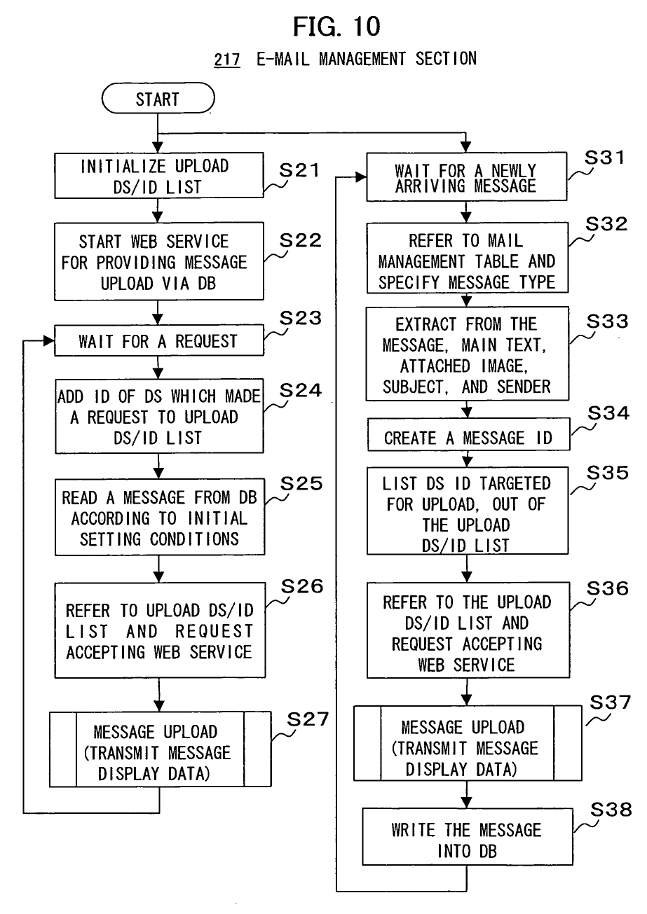

Next, according to the flow chart as shown in FIG. 10, operations of the e-mail management section 217 of the management server 200 will be explained.

When the e-mail management section 217 is started up, the processing branches into two ways, a processing regarding a message already stored in the database 220 and to a processing regarding a newly arriving message.

Firstly, a processing regarding the message stored in the database 220 will be explained, which is shown by the flow on the left in FIG. 10. When the e-mail management section 217 is started up, it initializes the upload DS ID list field of the mail management table 210, which has been explained with reference to FIG. 6, so as to manage the display terminal 100 utilizing a message upload via DB as a Web service (step 21). Next, the e-mail management section 217 issues the Web service for message upload via DB (step 22), and waits for a request for using the service (step 23). If there is a request for using the service, the e-mail management section 217 adds ID of the display terminal 100 that issues the request into the upload DS ID list field of the mail management table 210 (step 24). According to a series of processing as described above (steps 21 to 24), it is relatively free to modify the display area to be displayed on one display terminal 100. In other words, it is relatively free to change which display area is used, the display area A for displaying the SHARE type message, the display area B for displaying the SENDER type message, or the display area C for displaying the FREE type message.

Next, with reference to the mail management table 210, the e-mail management section 217 reads out a message from the database 220 according to initial setting conditions, the message being to be provided to the display terminal 100 having the ID which is indicated in the upload DS ID list field (step 25). Here, the initial setting conditions includes, for example, reading the latest five messages.

Next, the e-mail management section 217 refers to the DS management table 209 as described with reference to FIG. 5, requests the display terminal 100 having the ID indicated in the upload DS ID list field to render an accepting Web service, that is, to prepare for accepting a message (step 26), transmits data for displaying the message to the display terminal 100 having the ID indicated in the upload DS ID list field (step 27), and then waits for the next request.

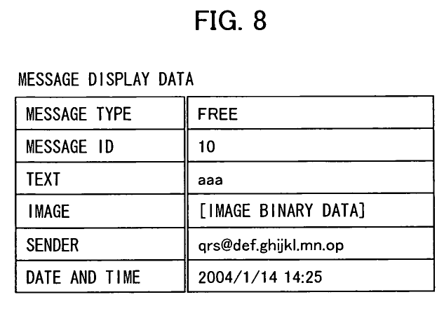

Here, data for displaying the message, which the e-mail management section 217 of the management server 200 transmits to the display terminal 100 includes, as shown in FIG. 8, message type, message ID being unique to the message, text data, image data, sender mail address, and date and time when the sender transmitted the mail. It is to be noted, in the example as shown in FIG. 8, the message type is FREE type with image data attached thereto, but if the message type is SHARE type, the image data is not attached.

Next, processing regarding a newly arriving message will be explained, which is shown by the flow on the right in FIG. 10.

When the e-mail management section 217 is started up, it waits for a newly arriving message. That is, it waits for a situation where the e-mail management section 217 receives a newly arriving message from the e-mail receiving section 216 (step 31). Next, the e-mail management section 217 refers to the mail management table 210 that was described with reference to FIG. 6, and specifies a message type of the newly arriving mail according to the mail address as a destination of the newly arriving mail (step 32). Then, the e-mail management section 217 extracts from the newly arriving message, text data, attached image data, subject line, sender name, and the like (step 33), and creates a message ID (step 34). Next, the e-mail management section 217 lists IDs indicated in the upload DS ID list field of the mail management table 210 (step 35), requests the display terminal 100 having the IDs thus listed to render an accepting Web service, i.e., to prepare for message accepting (step 36), and transmits to the display terminal the data for displaying message as described with reference to FIG. 8 (step 37). Subsequently, the e-mail management section 217 stores in the database 220 the data and the like extracted from the newly arriving e-mail (step 38), and waits for a new e-mail that will arrive next. In step 35, it is presumed that an ID of the display terminal 100 having already requested to use the Web service for providing message upload is stored in the upload DS ID list field of the mail management table 210. Thus, it means that the processing steps from 21 to 24 in the flow on the left side of FIG. 10 have already been executed. However, in the case where the management server 200 accepts a completely new e-mail, the same processes as those in steps 21 to 24 are performed at the time when the flow on the right side of FIG. 10 is started.

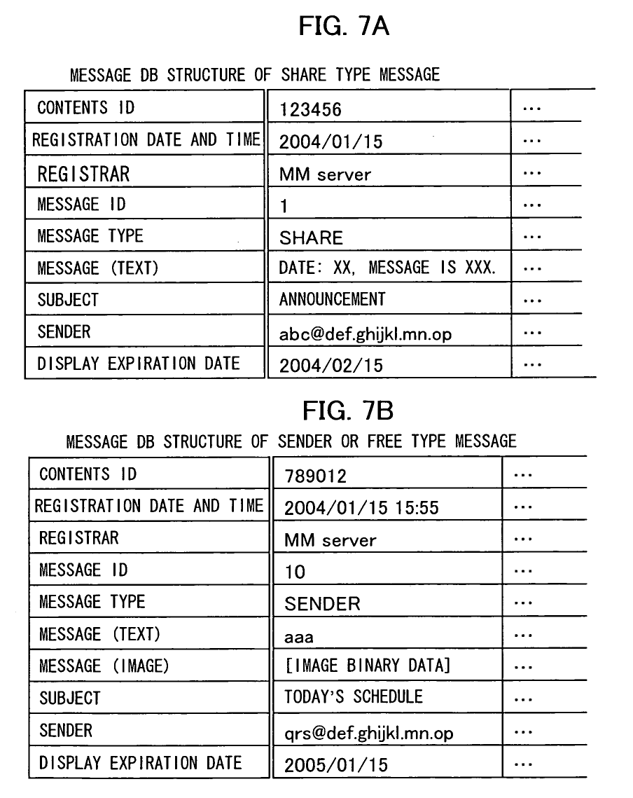

If the data and the like extracted from the newly arriving e-mail and stored in the database 220 (step 38) is SHARE type message, as shown in FIG. 7A, the data includes contents ID, registration date and time, registrar, message ID, message type, message of text data, subject of the message, sender mail address, and display expiration date. Out of those data elements, the e-mail management section 217 automatically sets the display expiration date, according to the registration date and time. If the message type is SENDER or FREE type, as shown in FIG. 7B, a message in a form of image data is attached in addition to the data of SHARE type message. In step 25 of FIG. 10, data constituting the message display data as shown in FIG. 8 is extracted, out of the data elements stored in the database 220 as described above. In this example here, the subject, display expiration date and the like out of the data stored in the database 220 are not included in the message display data. However, the subject, the display expiration date, and the like may be included in the message display data. If the display expiration date is included in the message display data, the display control section 117 of the display terminal 100 which has received this message display data may delete this message, when the display expiration date for the message passes.

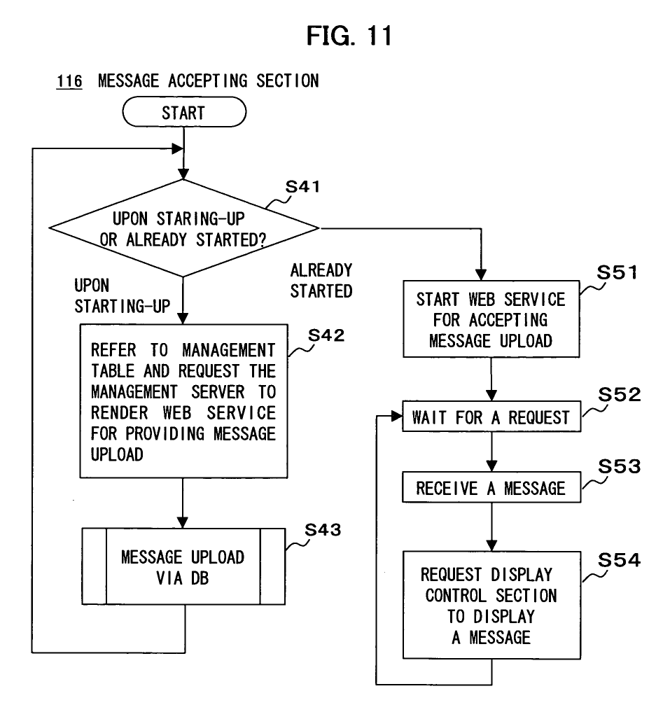

Next, according to the flow chart as shown in FIG. 11, operations of the message accepting section 116 of the display terminal 100 will be described.

When the message accepting section 116 is started up, it is determined whether the display terminal 100 is at the stage of started up or has already been started up (step 41). If it is at the stage of being started up, the message accepting section refers to the management table 109 as described with reference to FIG. 4A and FIG. 4B, and requests the management server 200 to render a Web service for providing message upload via DB (step 42). On this occasion, the message accepting section 116 informs what kind of message the display terminal 100 is requesting to provide with. Specifically, in the case of the display terminal A 100, the management table 109 as shown in FIG. 4A is referred to, and provision of a message of SHARE type to be displayed in the display area A, a message of SENDER type to be displayed in the display area B, a message of FREE type to be displayed in the display area C are requested. This request for the Web service for providing message upload via DB is accepted by the e-mail management section 217 in step 23 of FIG. 10.

After this request is sent to the management server 200, the message accepting section 116 receives message display data via DB from the management server 200 (step 43), and the processing returns to step 41.

In step 41, if it is determined that the display terminal 100 has already been started up, the message accepting section 116 issues a Web service for accepting message upload to the management server 200 (step 51), waits for requests from the management server 200, i.e., requests in step 26 and step 36 of FIG. 10 (step 52), and receives a message from the management server 200 (step 53). Subsequently, the message accepting section requests the display control section 117 to display the message (step 54). Then, while the message accepting section is actuated, the processes from step 52 to step 54 are executed repeatedly.

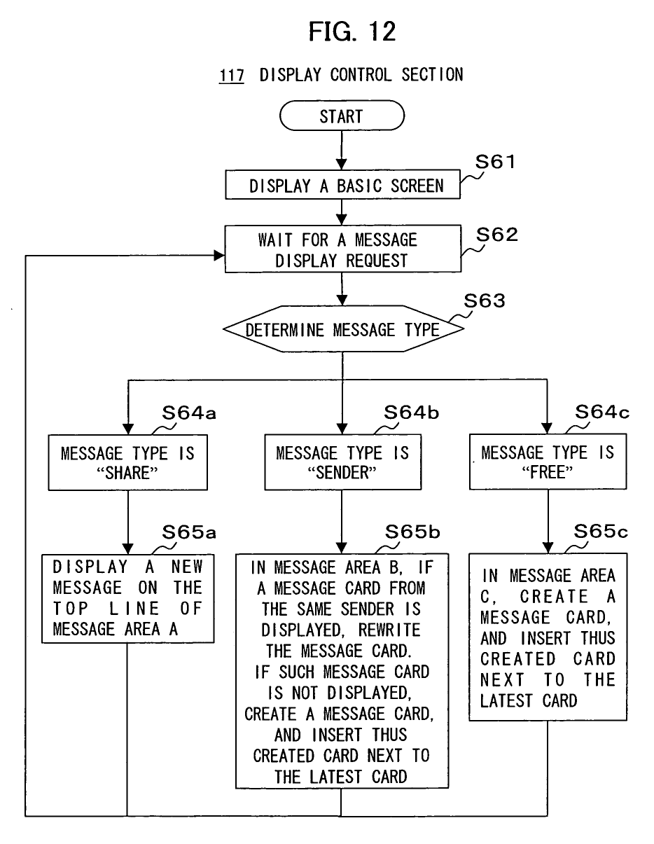

Next, operations of the display control section 117 of the display terminal A 100 will be explained according to the flow chart as shown in FIG. 12.

Firstly, the display control section 117 displays on the display unit 120, a screen having a background that is partitioned into multiple display areas A, B, and C (step 61), and waits for a display request from the message accepting section 116 (step 62). In receipt of the display request of a message, the display control section 117 determines the message type of thus received message (step 63).

When the display control section 117 determines that the message type is SHARE (step 64a), it displays a new message in the display area A on the top position out of the multiple display areas A, B, and C (step 65a), and returns to the step 62. When the display control section 117 determines that the message type is SENDER (step 64b), the display control section checks whether or not the display area B includes a message card sent from the same sender as the one who sent the message to be displayed now. If there is a message card from the same sender, the existing message is overwritten. If there is no message card from the same sender, a new message card is created, and the card thus created is inserted next to the latest card being displayed (step 65b). Then, the processing returns to step 63. When the display control section 117 determines that the message type is FREE (step 64c), a new message card is created in the display area C, and the card thus created is inserted next to the latest card being displayed (step 65c). Then, the processing returns to step 63.

While the display control section 117 displays the message, it moves the message card 125 within the display areas B and C, as described above with reference to FIG. 3. If the message is a reply to another message, a user designates a message ID to send the reply. Therefore, a newly arriving message as a reply holds a message ID which is the same as the ID of the original message. Considering this situation, the message card thus created is inserted next to the message card having the same message ID, and a series of messages can be displayed in sequence.

As described above, in the present embodiment, the display terminal 100 reserves multiple display areas respectively associated with e-mail addresses different from one another. Therefore, a sender of the display information sends the information to the e-mail address being associated with the display area where the user wishes to display the information, out of the multiple display areas, whereby the display information can be displayed on the display terminal 100. Accordingly, the sender is allowed to use a general-purpose communication terminal 1 (FIG. 1 and FIG. 2).

In the display terminal 100, the message accepting section 116 accepts a message, and when the display control section 117 accepts a message display request from the message accepting section 116, the display control section 117 displays the message. Therefore, it is not necessary to perform a particular browsing operation to view the message.

The information display system according to the present embodiment has an effect as described above. Therefore, for example, this system may be placed in a public space such as office and school, to facilitate sharing information among the people relating to the space. If the system is placed in a store, various kind of usage is available, for example, information such as limited-time sale is categorized in SHARE type, information such as staff introduction of store staffs or recommendation from the staffs is categorized as SENDER type, and information such as opinions from customers is categorized as FREE type.

In the information display system according to the present embodiment, the e-mail server 300 is provided independently from the management server 200. However, it is possible to provide one piece of server by implementing the function of the management server 200 in the e-mail server 300.

Each of the display terminals 100 according to the present embodiment is not provided with an e-mail address which is capable of directly receiving an e-mail from an external communication terminal 1, and addresses available within LAN 301 are provided. However, at least one e-mail address may be provided, to be associated with each display area on the display terminal 100, and each display terminal 100 may be allowed to receive an e-mail directly from the external communication terminal 1 or via a mail server. In this occasion, however, at least one mail address set in the display terminal 100 cannot be easily changed. Therefore, modifying the type of message being received may not be easily performed, unlike the above embodiment.

Alternatively, instead of the mail address as a destination (receiving side), a sending side mail address may be utilized for the purpose above.

1. A display control apparatus for displaying information items from outside on a screen of a display apparatus, comprising,
a receiver which receives said information items from the outside, and
a controller which allocates in said screen multiple display areas respectively associated with multiple communication addresses that are different from one another, and displays said information items in said display areas respectively, said information items being sent to said communication addresses respectively associated with said display areas.

2. The display control apparatus according to claim 1, wherein,
each of said communication addresses respectively associated with said display areas is determined by a type of said information item, and said controller changes a display mode of said display area in accordance with the type of said information item.

3. The display control apparatus according to claim 2, wherein,
said communication address in accordance with the type of said information item which is required to specify a sender of said information item is different from said communication address in accordance with the type of said information item which is not required to specify said sender.

4. The display control apparatus according to claim 2, wherein,
said communication address in accordance with the type of said information item which is to be announced to all persons likely to exist at a position where said display apparatus is installed, is different from said communication address in accordance with the type of said information item which is to be announced to a part of the persons likely to exist at the position where said display apparatus is installed.

5. The display control apparatus according to claim 1, wherein,
said controller displays said information items from multiple senders in at least one of said multiple display areas.

6. The display control apparatus according to claim 5, wherein,
said controller displays the latest information item from each of said multiple senders, in said display area to display said information items from said multiple senders.

7. The display control apparatus according to claim 1, wherein,
said controller displays said information items arranged in a predetermined direction in a number being equal to or less than a predetermined number, within at least one of said multiple display areas, and
said controller scrolls said screen along the predetermined direction, whereby said information items in a number more than the predetermined number are displayed cyclically.

8. The display control apparatus according to claim 1, wherein,
said controller displays said multiple information items within at least one of said multiple display areas, in order of receiving by said receiver.

9. The display control apparatus according to claim 1, wherein,
said controller displays in at least one of said multiple display areas, a predetermined number of information items out of said multiple information items received by said receiver, within a given period.

10. The display control apparatus according to claim 1, wherein,
said controller displays a character and an image in at least one of said multiple display areas.

11. A display control apparatus for displaying information items from outside on a screen of a display apparatus, comprising,
a receiver which receives said information items from the outside, and
a controller which displays on said screen said information items arranged in a predetermined direction in a number being equal to or less than a predetermined number, wherein
said controller scrolls said screen along the predetermined direction, whereby said information items in a number more than the predetermined number are displayed cyclically.

12. The display control apparatus according to claim 11, wherein,
the controller allocates in said screen multiple display areas respectively associated with multiple communication addresses that are different from one another, and displays said information items in said display areas respectively, said information items being sent to said communication addresses respectively associated with said display areas, and
said controller displays in at least one of said multiple display areas, multiple information items cyclically.

13. The display control apparatus according to claim 11, wherein,
said receiver makes a request to said controller to display said information items, when said receiver receives said information items from the outside, and
said controller displays said information items on said screen, when said controller receives said request from said receiver to display said information items.

14. The display control apparatus according to claim 12, wherein,
said receiver holds said multiple communication addresses.

15. An information display apparatus for displaying information items from outside, comprising,
a display device which displays said information items,
a receiver which receives said information items from the outside, and
a controller which allocates in a screen of said display device, multiple display areas respectively associated with multiple communication addresses that are different from one another, and displays said information items in said display areas respectively, said information items being sent to said communication addresses respectively associated with said display areas.

16. An information display apparatus for displaying information items from outside, comprising,
a display device which displays said information items,
a receiver which receives said information items from the outside, and
a controller which displays on a screen of said display device, said information items arranged in a predetermined direction in a number being equal to or less than a predetermined number, wherein
said controller scrolls said screen along the predetermined direction, whereby said information items in a number more than the predetermined number are displayed cyclically.

17. A display system comprising,
an information display apparatus which displays information items from outside, and
a management apparatus which delivers to said information display apparatus multiple information items from the outside via a network, wherein,
said information display apparatus comprises,
a display device which displays said information items,
a receiver which receives said information items from the outside, and
a controller which allocates in a screen of said display device, multiple display areas respectively associated with multiple communication addresses that are different from one another, and displays said information items in said display areas respectively, said information items being sent to said communication addresses respectively associated with said display areas, and
said management apparatus comprises,
a storage device which stores a table to hold an association between an identifier given to said information display apparatus and each of said multiple communication addresses, and
a management controller which refers to said table and transmits said information items destined to the communication address, to said information display apparatus that is given the identifier associated with the communication address.

18. A management apparatus which receives information items from outside and delivers said information items to an information display apparatus via a network, comprising,
a receiver which receives said information items sent from outside to multiple communication addresses,
a storage device which stores a table holding said multiple communication addresses, a type of each of said information items respectively associated with said communication addresses, and an identifier of said information display apparatus associated with each of said communication addresses, and
a managing device which refers to said table, so as to find out the identifier of said information display apparatus to which said information item is to be sent, said information item having been sent to any one of said multiple communication addresses, and to find out the type of said information item, and transmits said information item and the type of said information item to said information display apparatus having said identifier.

19. The management apparatus according to claim 18, wherein,
said managing device receives from said information display apparatus, a request for any one of the types of said information items, and creates said table based on said request from said information display apparatus.

20. A display system comprising,
an information display apparatus which displays information items from outside, and
a management apparatus which delivers to said information display apparatus multiple information items from the outside via a network, wherein,
said information display apparatus comprises,
a display device which displays said information items,
a receiver which receives said information items from the outside, and
a controller which allocates in a screen of said display device, multiple display areas respectively associated with multiple communication addresses that are different from one another, and displays said information items in said display areas respectively, said information items being sent to said communication addresses respectively associated with said display areas, wherein,
said management apparatus comprises,
a receiver which receives said information items sent from outside to multiple communication addresses,
a storage device which stores a table holding said multiple communication addresses, a type of each of said information items respectively associated with said communication addresses, and an identifier of said information display apparatus associated with each of said communication addresses, and
a managing device which refers to said table, so as to find out the identifier of said information display apparatus to which said information item is to be sent, said information item having been sent to any one of said multiple communication addresses, and to find out the type of said information item, and transmits said information item and the type of said information item to said information display apparatus having said identifier.

21. A program to be executed on a computer, which allows said computer to display information items from outside on a screen of a display apparatus, comprising,
an allocating step of allocating in said screen, multiple display areas respectively associated with multiple communication addresses different from one another, and
a displaying step of displaying said information items in said display areas respectively, said information items having been sent to said communication addresses respectively associated with said display areas.

22. The program according to claim 21, wherein,
each of said communication addresses being set with respect to each of said display areas is determined by a type of said information item, and in said displaying step, a display mode of each of said display areas is changed in accordance with the type of said information item.

23. The program according to claim 21, wherein,
when a receiver of said computer on which said program operates receives said information items from outside and issues a request for displaying said information items, in said displaying step, said request is received and said information items is displayed in said display areas respectively associated with said information items.

24. A program to be executed on a computer, which allows said computer to receive information items from outside and to deliver said information items to an information display apparatus via a network, comprising,
a receiving step of receiving said information items sent from the outside to multiple communication addresses, and
a transmitting step of referring to a table holding said multiple communication addresses, a type of each of said information items respectively associated with said communication addresses, and an identifier of said information display apparatus associated with each of said communication addresses, so as to find out the identifier of said information display apparatus to which said information item is to be sent, said information item having been sent to any one of said multiple communication addresses, and to find out the type of said information item, and transmitting said information item and the type of said information item to said information display apparatus having said identifier.

25. The program according to claim 24, wherein,
in said transmitting step, a request for any type of said information items is received from said information display apparatus, and said table is created based on said request from said information display apparatus.

26. A display control method of displaying information items from outside on a screen of a display apparatus, comprising,
an allocating step of allocating in said screen, multiple display areas respectively associated with multiple communication addresses different from one another, and
a displaying step of displaying said information items in said display areas respectively, said information items being sent to said communication addresses respectively associated with said display areas.

27. The display control method according to claim 26, wherein,
each of said communication addresses being set with respect to each of said display areas is determined in accordance with a type of said information item, and in said displaying step, a display mode in each of said display areas is changed in accordance with the type of said information item.

28. A display system comprising a display terminal, and a management apparatus being connected to said display terminal via a network, wherein,
a screen of said display terminal includes multiple display areas,
said display areas respectively display mail addresses being associated with said display areas respectively,
said management apparatus comprises,
a first storage device which stores a first management information item defining a type of message associated with each of said mail addresses, and
a first controller which extracts a mail address from a mail that is sent from a user terminal, refers to said first management information to determine the type of said message associated with said mail address thus extracted, attaches said type of said message thus determined to said message, and transmits to said display terminal said message with the type of message attached thereto, and,
said display terminal comprises,
a second storage device which stores a second management information item defining a type of message associated with each of said display areas, and
a second controller which refers to said second management information item to determine a display area associated with said type of message, attached to said message received from said management apparatus, and displays said message in said display area thus determined.
